(19) United States
(12) Patent Application Publication
(10) Pub. No.: US 2018/0129970 A1
(43) Pub. Date: May 10, 2018

(54) FORWARD-LOOKING MACHINE LEARNING FOR DECISION SYSTEMS

(71) Applicants: Justin E. Gottschlich, San Jose, CA (US); Thijs Metsch, Koln (NL); Leonard Truong, Redwood City, CA (US); Tatiana Shpeisman, Menlo Park, CA (US); Sara S. Baghsorkhi, Los Gatos, CA (US)

(72) Inventors: Justin E. Gottschlich, San Jose, CA (US); Thijs Metsch, Koln (NL); Leonard Truong, Redwood City, CA (US); Tatiana Shpeisman, Menlo Park, CA (US); Sara S. Baghsorkhi, Los Gatos, CA (US)

(21) Appl. No.: 15/348,678

(22) Filed: Nov. 10, 2016

(51) Int. Cl. G06N 99/00; G06N 5/04

(52) U.S. Cl. CPC G06N 99/005; G06N 5/045

(57) ABSTRACT

A machine-learning decision system includes an online decision system and an offline decision system. The online decision system produces a first time slice-specific decision output corresponding to a first time slice based on one or more situational inputs received in the first time slice. The offline decision system produces a second Lime slice-specific decision output corresponding to the first time slice based on one or more situational inputs received in the first time slice and in a plurality of subsequent time slices occurring after the first time slice. The system further includes an online training system that conducts negative-reinforcement training of the online decision system in response to a nonconvergence between the first and the second time slice-specific decision outputs.

### TECHNICAL FIELD

Embodiments described herein generally relate to improvements in computing performance for information processing and automated data analytics systems. More particularly, the embodiments relate to trainable decision systems that perform predictive assessments based on time-series input.

### BACKGROUND

Machine learning encompasses a variety of computational techniques used to devise models and algorithms that lend themselves to performing predictive assessments. As an example, one class of application utilizing machine learning is anomaly detection, which entails detecting items, such as events, that fall outside an expected pattern, or otherwise differ from other items in a dataset. Anomalies are generally abnormal, unwanted, or unexpected within a given context. One challenge faced by designers of such systems is that the majority of types of anomalous items to be detected are not known in advance, and are thus not definable in terms of characteristics or patterns of indicia.

In many applications, such as complex data centers, self-driving vehicles, security systems, medical treatment systems, transaction systems, and the like, the detection of anomalies is expected to occur in real time, i.e., with short latency from the present. This expectation complicates the training of decision systems. Conventional training methods including supervised machine learning, unsupervised learning, and reinforcement learning, tend to be either too slow (i.e., not suitable for real-time, or online learning on the fly), or lacking accuracy when assessing predictions based on past or present results. A practical, computationally-efficient solution is needed for decision systems for anomaly-detection, and various other applications.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a high-level diagram illustrating a machine-learning decision system (MLDS) according to some embodiments.

FIGS. 2A and 2B are timeline diagrams illustrating real-time decision-making operation and forward-looking decision operation performed by the MLDS system of FIG. 1 according to some embodiments.

FIGS. 3A and 3B are block diagrams illustrating an example architecture of a discrete-time-series data preprocessor engine according to some embodiments.

FIG. 4 is a block diagram illustrating an exemplary system architecture of a processor-based computing device according to an embodiment.

FIG. 5 is a diagram illustrating an exemplary hardware and software architecture of a computing device such as the one depicted in FIG. 4, in which various interfaces between hardware components and software components are shown.

FIG. 6 is a block diagram illustrating examples of processing devices that may be implemented on a computer system, such as the computer system described with reference to FIGS. 4-5, according to some embodiments.

FIG. 7 is a block diagram illustrating example components of a CPU as one of the processing devices depicted in FIG. 6, according to various embodiments.

FIG. 8 is a flow diagram illustrating example operation of the discrete-time-series data preprocessor engine and an MLDS according to an embodiment.

### DETAILED DESCRIPTION

Aspects of the embodiments are directed to decision systems, components thereof, and methods of their operation. In the present context, a decision system is a device, or tangible component of a device or greater computer system, that is constructed, programmed, or otherwise configured, to execute prediction and machine-learning-related operations based on input data. Examples of decision systems include, without limitation, association rule systems, artificial neural networks, deep neural networks, clustering systems, support vector machines, classification systems, and the like.

Input data may be situational data representing one or more states of a system, one or more occurrences of events, sensor output, telemetry signaling, one or more stochastic variables, or the like. In some embodiments, the situational data may include sensed data monitored by a sensor system, such as in a self-driving vehicle. In other embodiments, the sensed data may include monitored data from a data-processing system such as a data center, intrusion detection system, or the like.

It will be understood that a suitable variety of implementations may be realized in which a decision system is provided as a dedicated unit, or as part of a computing platform through the execution of program instructions. The computing platform may be one physical machine, or may be distributed among multiple physical machines, such as by role or function, or by process thread in the case of a cloud computing distributed model. In various embodiments certain operations may run in virtual machines that in turn are executed on one or more physical machines. It will be understood by persons of skill in the art that features of the embodiments may be realized by a variety of different suitable machine implementations.

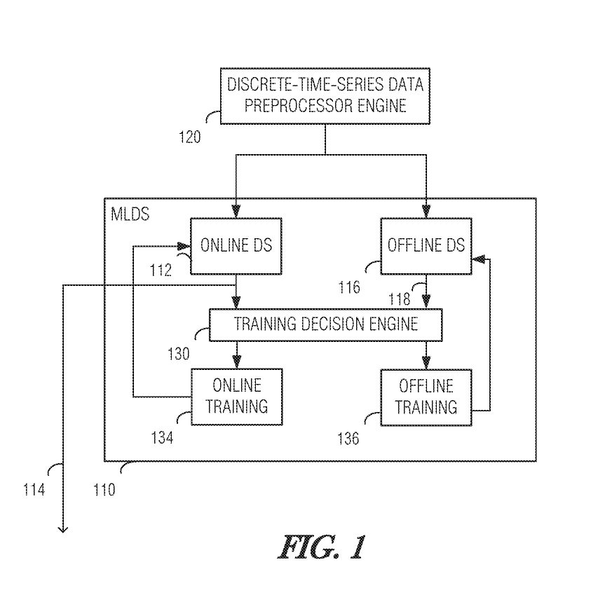

FIG. 1 is a high-level diagram illustrating a machine-learning decision system (MLDS) according to some embodiments. As depicted, MLDS 110 includes at two types of decision systems (DS); online DS 112, and offline DS 116. Each DS 112, 116 may operate in a discrete-time regime, where input is received, and decision output is generated, in time slices, or discrete-time steps. Discrete time steps in the present context represent operational cycles of MLDS 110, with each operational cycle corresponding to a time interval during which various inputs may be received, and in which a decision is generated, by each DS 112, 116 of MDLS 110. In an example system, each decision output of online DS 112 and offline DS 116 is specific to a corresponding time slice.

Each DS 112, 116 receives the same input, such as via discrete-time-series data preprocessor engine 120, embodiments of which are described in greater detail below. Online DS 112 produces real-time decision output 114 for each time slice based (at least in part) on the input received in that time slice. In some embodiments, online DS 112 may also take into account input from prior time slices in computing real-time decision output 114 for a given time slice.

In the present context, real-time operation refers to production of real-time decision output 114 within the same time slice in which the input upon which the decision output 114 is based is received. Real-time operation may also include some tolerable delay, such as the case where the real-time decision output 114 is produced within a close time slice, such as a next subsequent time slice following the time slice in which the input upon which the decision output is based, is received. In the latter case, the close time slice is within a tolerable latency period defined for the system. As depicted in FIG. 1, real-time decision output 114 may be provided to a supervisory system to be acted upon in the context of the greater application, such as a control system that uses the real-time decision output 114 as an input to a control algorithm, for example.

Offline DS 116 does not produce real-time decision output corresponding to the current or tolerably-recent time slice. Instead, offline DS 116 continues collecting input data from subsequent time slices beyond the current time slice, for a defined number of time slices, and computes a forward-looking decision output 118 corresponding to the current time slice based on the current time slice's input, as well as on the subsequent input. Notably, from the temporal frame of reference of the current time slice, input data from the subsequent time slices would appear as forward-looking, or future, input data. In general, forward-looking decision output 118, being based on future insight, is presumed to be a more accurate prediction than real-time decision output 114.

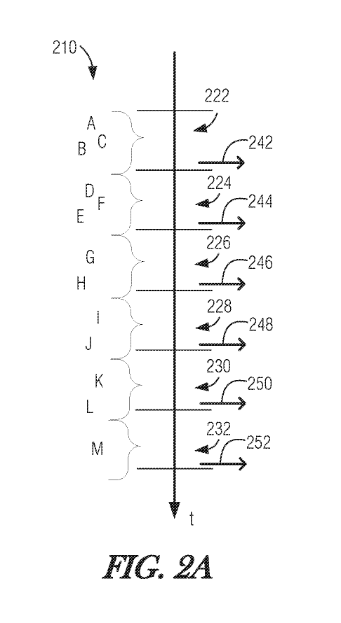

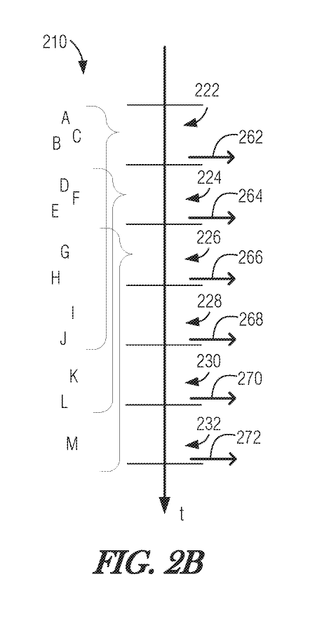

To illustrate further, FIGS. 2A and 2B are timeline diagrams illustrating real-time decision-making operation and forward-looking decision operation performed respectively by DS 112 and DS 116. FIG. 2A illustrates real-time decision-making operation by DS 112. Inputs 210, labeled A-M occur at various points in time t, and are captured and assigned to corresponding time slices 222-232 in which the capture occurs. In each time slot 222-232, DS 112 generates a real-time decision output 114, which for each of the individual time slices 222-232, is indicated respectively at 242-252. Each time slice-specific real-time decision output 242-252 is based on the inputs corresponding to the time slot. For instance, in time slot 222, inputs A, B, and C are used as bases for real-time decision output 242; inputs D, E, and F are the basis for real-time decision output 244 for time slice 224, and so forth.

FIG. 2B illustrates forward-looking decision operation performed by DS 116. The operation illustrated may take place concurrently with the real-time decision operation depicted in FIG. 2A. Inputs 210 and time slices 222-232 are as discussed above. However, each of the forward looking decision outputs 218, with time-slice-specific forward-looking decision outputs 262-272 are based on different groupings of inputs. As exemplified in FIG. 2B, forward-looking decision output 262 corresponding to time slice 222 is based on inputs A-J, which are associated with time slices 222-228. In this example, inputs D-F, G-H. and I-J, respectively corresponding to time slices 224-228, are future-occurring inputs from the perspective of time slice 222. In similar fashion, as illustrated, forward-looking decision 264 is based on inputs D-L corresponding to time slices 224-230, and forward-looking decision output 266 is based on inputs G-M corresponding to time slices 226-232.

Real-time decision output 114 and forward-looking decision output 118 may each be in the form of a binary state or value (for instance representing either the presence, or the absence, of an anomaly), or they may be a numerical score (e.g., 0-99) indicating a strength or confidence score of the assessment of an anomaly. Each of the outputs 114, 118, corresponding to the same time slice, is fed to training decision engine 130, which is constructed, programmed, or otherwise configured, to generate a decision as to whether training of online DS 112, offline DS 116, or both, is warranted. A decision to perform training may be based on nonconvergence or convergence between the outputs 114, 118, and on the extent thereof. For example, in response to nonconvergence between the assessments made by online DS 112 and offline DS 116, training decision engine 130 may call for negative reinforcement training of online DS 112, positive reinforcement training of offline DS 116, or both.

Online training engine 134 is constructed, programmed, or otherwise configured, to train online DS 112 based on a result of the operation of training decision engine 130. In an example, this training may be considered to be a form of reinforcement training, either negative or positive. In a related embodiment, only negative reinforcement training is performed of online DS 112 by online training engine 134. Offline training engine 136 is constructed, programmed, or otherwise configured, to train offline DS 116. In an example, this training may be considered to be a form of unsupervised learning.

Online DS 112 and offline DS 116 may each be subject to training by online training engine 134, and offline training engine 136, respectively, as often as every time slice. Thus, the training may effectively provide constant, real-time, unsupervised and reinforced learning for online DS 112 and offline DS 116.

In a related embodiment, for each of online training engine 134, and offline training engine 136, the training parameters are dynamically set in response to various circumstances. For instance, learning rate and learning iterations may be set as a run-time heuristic based on the timing and extent of the most recent training applied, extent of convergence or nonconvergence between the values of outputs 114, 118, and other such factors.

In various embodiments, these components are implemented as engines, circuits, components, or modules, which for the sake of consistency are termed engines, although it will be understood that these terms may be used interchangeably. Engines may be hardware, software, or firmware communicatively coupled to one or more processors in order to carry out the operations described herein. Engines may be hardware engines, and as such engines may be considered tangible entities capable of performing specified operations and may be configured or arranged in a certain manner. In an example, circuits may be arranged (e.g., internally or with respect to external entities such as other circuits) in a specified manner as an engine. In an example, the whole or part of one or more hardware processors may be configured by firmware or software (e.g., instructions, an application portion, or an application) as an engine that operates to perform specified operations. In an example, the software may reside on a machine-readable medium. In an example, the software, when executed by the underlying hardware of the engine, causes the hardware to perform the specified operations. Accordingly, the term hardware engine is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein.

Considering examples in which engines are temporarily configured, each of the engines need not be instantiated at any one moment in time. For example, where the engines comprise a general-purpose hardware processor core configured using software; the general-purpose hardware processor core may be configured as respective different engines at different times. Software may accordingly configure a hardware processor core, for example, to constitute a particular engine at one instance of time and to constitute a different engine at a different instance of time.

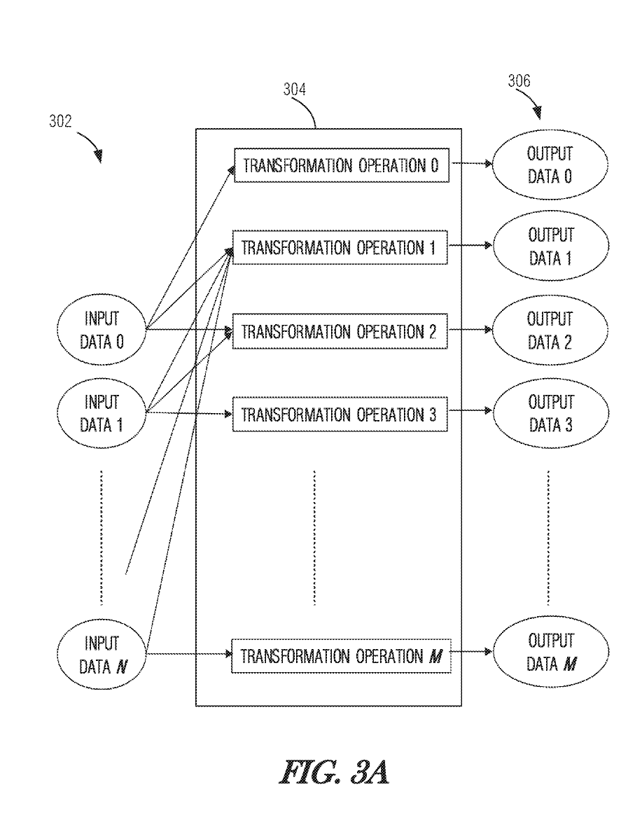

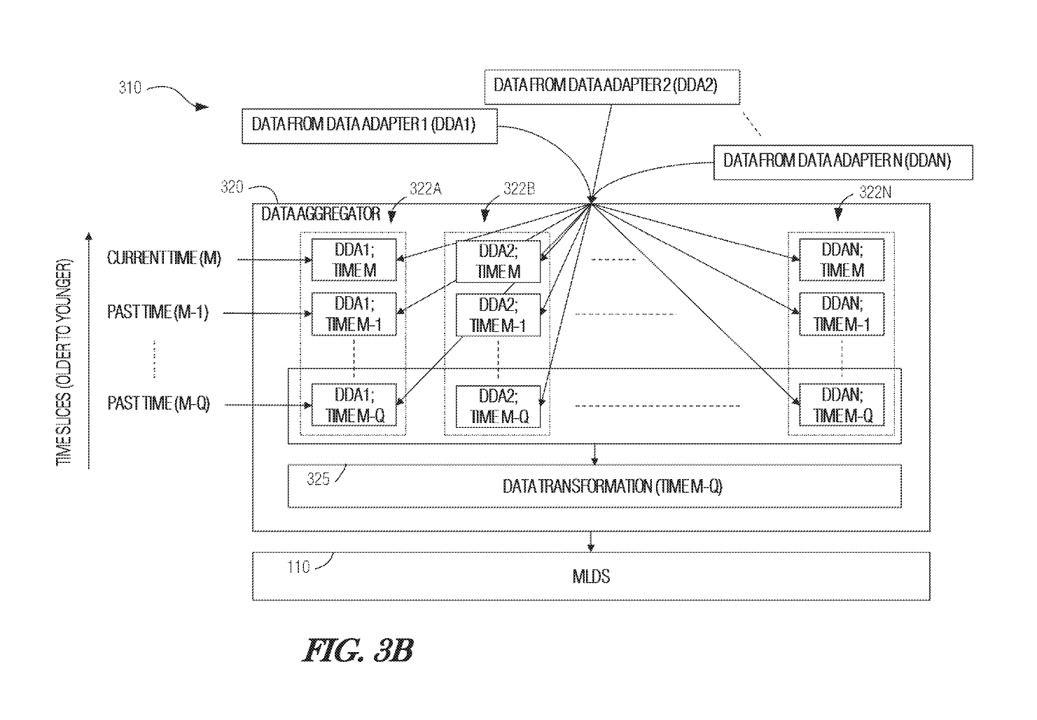

FIGS. 2A and 2B are block diagrams illustrating an example architecture of discrete-time-series data preprocessor engine 120 according to some embodiments. FIG. 3A illustrates an example data adapter architecture, whereas FIG. 3B illustrates an example data aggregator architecture that processes the output from one or more data adapters.

Data adapter 304 is an input-output transformation engine. As depicted, data adapter 304 receive input data 302 and generates output data 306 in a transformed fashion. In practice, data adapter 304 may transform sensor data, telemetry data, or the like, of a particular subsystem into a format that can be processed by the data aggregator described in greater detail below. In turn, the aggregated data is consumed as input by the MLDS.

Data adapter 304 may have a uniform, or non-uniform configuration according to various embodiments. Non-uniform transformations in this context are those transformations that take N inputs and generate M outputs, where N and M may not be equal quantities (e.g., M may be smaller, larger, or equal to N) and both are greater than or equal to 1.

The transformations that data adapter 304 may perform may be customizable, heterogeneous, and may range anywhere from single input transformations to a complex multi-dimensional transformations of an unbounded input size (e.g., a matrix where the rows represent a snapshot of time-series data of a single input and the columns represent a snapshot of all inputs for a single point in time).

In the example depicted, a non-uniform data adapter is shown in FIG. 3A, where the input vector has N data elements, while the output vector has M data elements, which is larger than N. The actual transformations that are performed by the data adapter 304 may be customized to the specific combination of an individual subsystem and the MLDS's architecture.

FIG. 3B depicts an example architecture of data aggregator 320 according to an embodiment. Data aggregator 320 is a data processing engine that takes input data 310 from N sources and performs a time-ordered restructuring of that input data. Data 310 from each of the N data sources is stored in its own queue 322A, 322B, . . . , 322N of length Q. Because there are N queues, each of size Q, the data aggregator maintains an internal matrix of data elements of size N×Q as shown. The value assigned to Q is the number of time slices that are buffered for reliable data processing for the MLDS 110.

Each of the data aggregator's queues contains Q number of entries. The number of entries serves as a time-buffering mechanism to ensure data that might be missing due to delays or out-of-sequence arrival does not cause incorrect data delivery to MLDS 110.

Once the current time, M, plus Q is reached, data aggregator 320 accumulates the oldest time series data from its queues (the Qth elements) and sends it to its final data transformation (FDT) handler 325. Once the data for time slice M-Q is received by the FDT handler 325, a data transformation may be made to the data and then it is output to MLDS 110.

In a related embodiment, the FDT handler 325 is permitted to read data from any of the Q elements in the N queues. This approach allows the FDT handler 325 to perform time-series filtering of the data before sending the data to the MLDS 110.

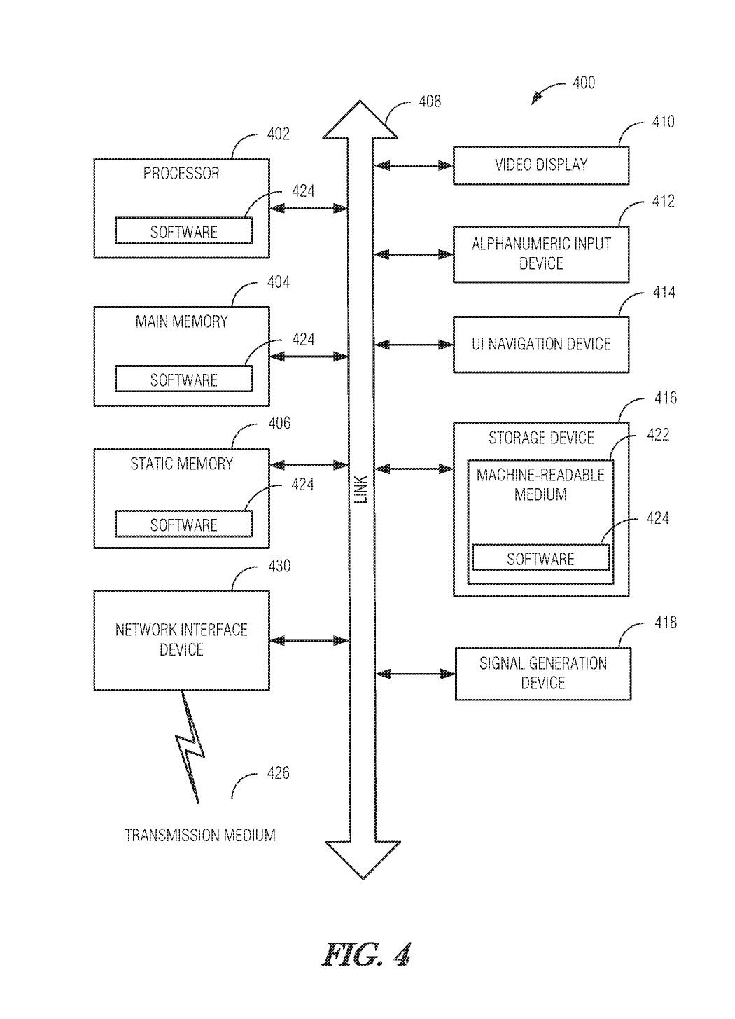

FIG. 4 is a block diagram illustrating a computer system in the example form of a general-purpose machine. In certain embodiments, programming of the computer system 400 according to one or more particular algorithms produces a special-purpose machine upon execution of that programming, to form discrete-time-series data preprocessor engine 120 and MLDS 110, among other subsystems. In a networked deployment, the computer system may operate in the capacity of either a server or a client machine in server-client network environments, or it may act as a peer machine in peer-to-peer (or distributed) network environments.

Example computer system 400 includes at least one processor 402 (e.g., a central processing unit (CPU), a graphics processing unit (GPU) or both, processor cores, compute nodes, etc.), a main memory 404 and a static memory 406, which communicate with each other via a link 408 (e.g., bus). The computer system 400 may further include a video display unit 410, an alphanumeric input device 412 (e.g., a keyboard), and a user interface (UI) navigation device 414 (e.g., a mouse). In one embodiment, the video display unit 410, input device 412 and UI navigation device 414 are incorporated into a touch screen display. The computer system 400 may additionally include a storage device 416 (e.g., a drive unit), a signal generation device 418 (e.g., a speaker), a network interface device (NID) 420, and one or more sensors (not shown), such as a global positioning system (GPS) sensor, compass, accelerometer, or other sensor.

The storage device 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404, static memory 406, and/or within the processor 402 during execution thereof by the computer system 400, with the main memory 404, static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database, and/or associated caches and servers) that store the one or more instructions 424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices, magnetic disks such as internal hard disks and removable disks; magneto-optical disks; and CD-ROM and DVD-ROM disks.

NID 430 according to various embodiments may take any suitable form factor. In one such embodiment. NID 420 is in the form of a network interface card (NIC) that interfaces with processor 402 via link 408. In one example, link 408 includes a PCI Express (PCIe) bus, including a slot into which the NIC form-factor may removably engage. In another embodiment, NID 420 is a network interface circuit laid out on a motherboard together with local link circuitry, processor interface circuitry, other input/output circuitry, memory circuitry, storage device and peripheral controller circuitry, and the like. In another embodiment, NID 420 is a peripheral that interfaces with link 408 via a peripheral input/output port such as a universal serial bus (USB) port. NID 420 transmits and receives data over transmission medium 426, which may be wired or wireless (e.g., radio frequency, infra-red or visible light spectra, etc.), fiber optics, or the like.

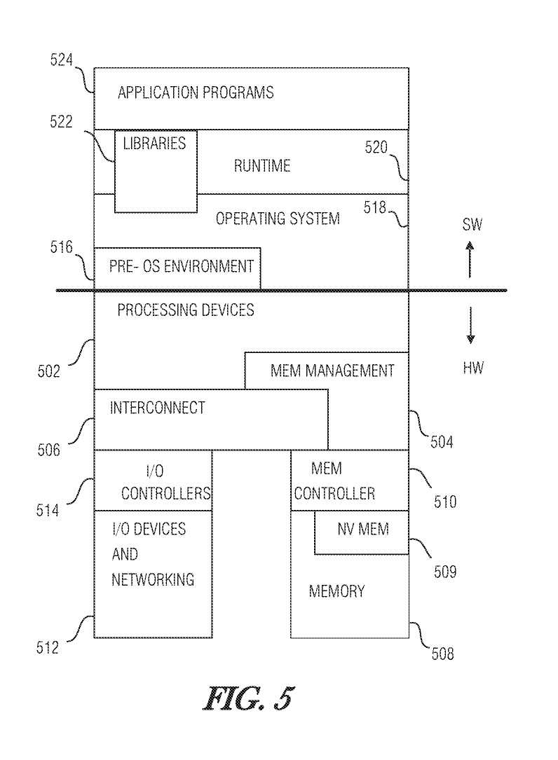

FIG. 5 is a diagram illustrating an exemplary hardware and software architecture of a computing device such as the one depicted in FIG. 4, in which various interfaces between hardware components and software components are shown. As indicated by HW, hardware components are represented below the divider line, whereas software components denoted by SW reside above the divider line. On the hardware side, processing devices 502 (which may include one or more microprocessors, digital signal processors, etc., each having one or more processor cores, are interfaced with memory management device 504 and system interconnect 506. Memory management device 504 provides mappings between virtual memory used by processes being executed, and the physical memory. Memory management device 504 may be an integral part of a central processing unit which also includes the processing devices 502.

Interconnect 506 includes a backplane such as memory, data, and control lines, as well as the interface with input/output devices, e.g., PCI, USB, etc. Memory 508 (e.g., dynamic random access memory—DRAM) and non-volatile memory 509 such as flash memory (e.g., electrically-erasable read-only memory—EEPROM, NAND Flash, NOR Flash, etc.) are interfaced with memory management device 504 and interconnect 506 via memory controller 510. This architecture may support direct memory access (DMA) by peripherals in some embodiments. I/O devices, including video and audio adapters, non-volatile storage, external peripheral links such as USB, Bluetooth, etc., as well as network interface devices such as those communicating via Wi-Fi or LTE-family interfaces, are collectively represented as I/O devices and networking 512, which interface with interconnect 506 via corresponding I/O controllers 514.

On the software side, a pre-operating system (pre-OS) environment 516, which is executed at initial system start-up and is responsible for initiating the boot-up of the operating system. One traditional example of pre-OS environment 516 is a system basic input/output system (BIOS). In present-day systems, a unified extensible firmware interface (UEFI) is implemented. Pre-OS environment 516, is responsible for initiating the launching of the operating system, but also provides an execution environment for embedded applications according to certain aspects of the invention.

Operating system (OS) 518 provides a kernel that controls the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 518 provides device drivers, and a variety of common services such as those that facilitate interfacing with peripherals and networking, that provide abstraction for application programs so that the applications do not need to be responsible for handling the details of such common operations. Operating system 518 additionally provides a graphical user interface (GUI) that facilitates interaction with the user via peripheral devices such as a monitor, keyboard, mouse, microphone, video camera, touchscreen, and the like.

Runtime system 520 implements portions of an execution model, including such operations as putting parameters onto the stack before a function call, the behavior of disk input/output (I/O), and parallel execution-related behaviors. Runtime system 520 may also perform support services such as type checking, debugging, or code generation and optimization.

Libraries 522 include collections of program functions that provide further abstraction for application programs. These include shared libraries, dynamic linked libraries (DLLs), for example. Libraries 522 may be integral to the operating system 518, runtime system 520, or may be added-on features, or even remotely-hosted. Libraries 522 define an application program interface (API) through which a variety of function calls may be made by application programs 524 to invoke the services provided by the operating system 518. Application programs 524 are those programs that perform useful tasks for users, beyond the tasks performed by lower-level system programs that coordinate the basis operability of the computing device itself.

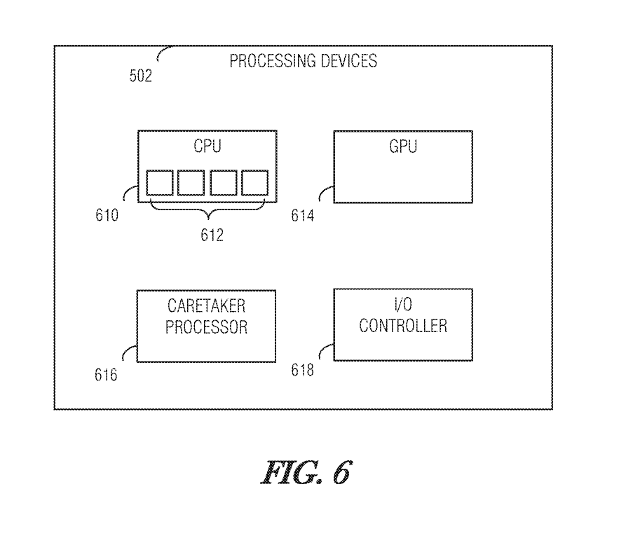

FIG. 6 is a block diagram illustrating processing devices 502 according to some embodiments. In one embodiment, two or more of processing devices 502 depicted are formed on a common semiconductor substrate. CPU 610 may contain one or more processing cores 612, each of which has one or more arithmetic logic units (ALU), instruction fetch unit, instruction decode unit, control unit, registers, data stack pointer, program counter, and other essential components according to the particular architecture of the processor. As an illustrative example, CPU 610 may be a x86-type of processor. Processing devices 502 may also include a graphics processing unit (GPU) 614. In these embodiments, GPU 614 may be a specialized co-processor that offloads certain computationally-intensive operations, particularly those associated with graphics rendering, from CPU 610. Notably, CPU 610 and GPU 614 generally work collaboratively, sharing access to memory resources, I/O channels, etc.

Processing devices 502 may also include caretaker processor 616 in some embodiments. Caretaker processor 616 generally does not participate in the processing work to carry out software code as CPU 610 and GPU 614 do. In some embodiments, caretaker processor 616 does not share memory space with CPU 610 and GPU 614, and is therefore not arranged to execute operating system or application programs. Instead, caretaker processor 616 may execute dedicated firmware that supports the technical workings of CPU 610, GPU 614, and other components of the computer system. In some embodiments, caretaker processor is implemented as a microcontroller device, which may be physically present on the same integrated circuit die as CPU 610, or may be present on a distinct integrated circuit die. Caretaker processor 616 may also include a dedicated set of I/O facilities to enable it to communicate with external entities. In one type of embodiment, caretaker processor 616 is implemented using a manageability engine (ME) or platform security processor (PSP). Input/output (I/O) controller 618 coordinates information flow between the various processing devices 610, 614, 616, as well as with external circuitry, such as a system interconnect.

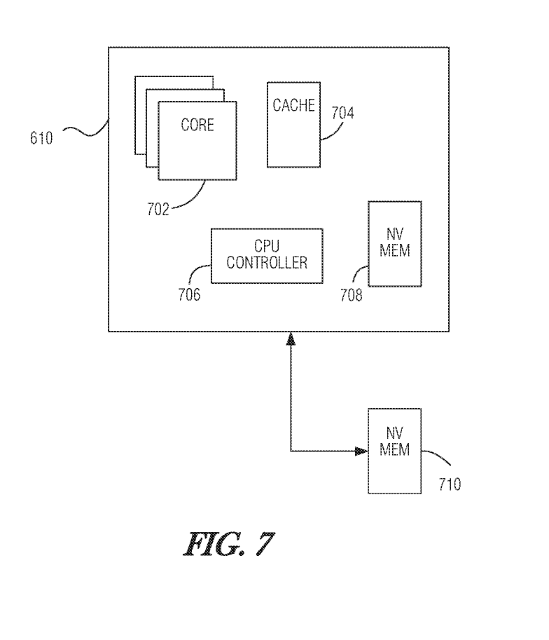

FIG. 7 is a block diagram illustrating example components of CPU 610 according to various embodiments. As depicted, CPU 610 includes one or more cores 702, cache 704, and CPU controller 706, which coordinates interoperation and tasking of the core(s) 702, as well as providing an interface to facilitate data flow between the various internal components of CPU 610, and with external components such as a memory bus or system interconnect. In one embodiment, all of the example components of CPU 610 are formed on a common semiconductor substrate.

CPU 610 includes non-volatile memory 708 (e.g., flash, EEPROM, etc.) for storing certain portions of foundational code, such as an initialization engine, and microcode. Also, CPU 610 may be interfaced with an external (e.g., formed on a separate IC) non-volatile memory device 710 that stores foundational code that is launched by the initialization engine, such as system BIOS or UEFI code.

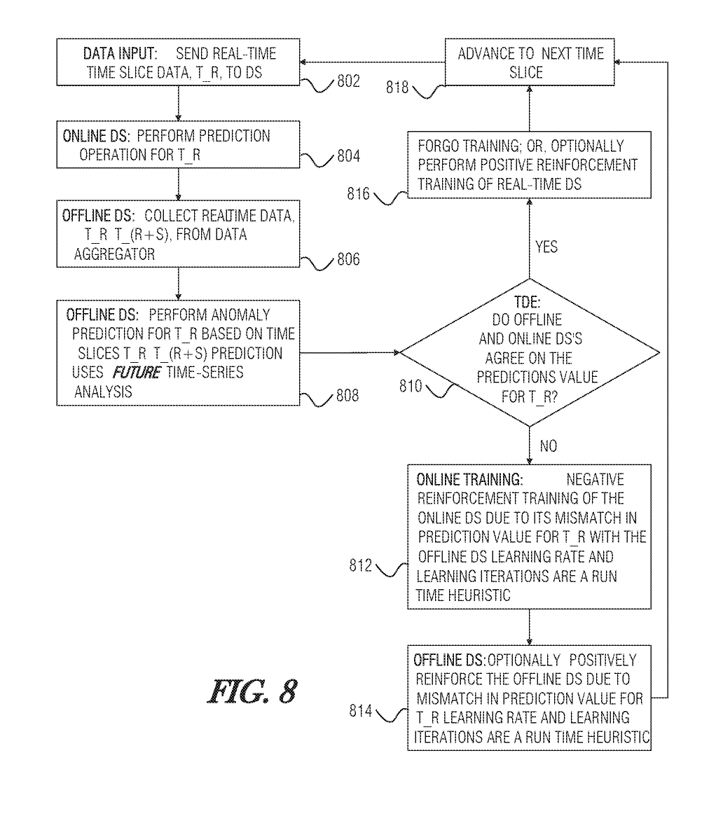

FIG. 8 is a flow diagram illustrating example operation of the discrete-time-series data preprocessor engine 120 and MLDS 110 according to an embodiment. At the outset, online DS 112 and offline DS 116 may each be pre-trained using classical neural network techniques in a supervised setting using historical, pre-classified data, for example. Next, these DS's are made live, at which point they begin consuming real-time data provided by data preprocessor engine 120, and begin making real-time predictions for anomalous events. Accordingly, at 802, data preprocessor engine 120 operates to provide real-time data at the current time slice, T_R, to online DS 112 and offline DS 116.

Once real-Lime data is being provided, at 804, online DS 112 computes a real-time score for current time slice T_R. The real-time score that is generated predicts whether or not an anomaly has occurred at time slice T_R. At 806, offline DS 116 collects incoming data from data preprocessor engine 120 over a S number of time slices and uses this “future” data—from the temporal perspective of T_R—to calculate its own real-time score for the time slice T_R at 808.

The prediction performed at operation 808 by offline DS 116 is different from the prediction performed by online DS at 112 because it uses forward-looking data of T_(R+1) . . . T_(R+S) to calculate the prediction value for T_R. Thus, when calculating whether or not an anomaly has occurred for T_R, offline DS 116 uses data from what is perceived as future time slice data (T_(R+1) . . . T_(R+S)). By using these future time slices to determine if an anomaly has occurred in the past (i.e., at time slice T_R), offline DS 116 has a greater likelihood for determining a correct anomaly prediction than the online DS 112.

Next, at decision 810, training decision engine 130 assesses whether or not the offline DS 116 has predicted a value that is the same as, or different than, the value predicted by online DS 112.

In one approach, if the values match (either identically, or within some predefined margin), training may be skipped altogether at 816. In another approach, positive reinforcement training of online DS 112 may be performed to some extent. Notably, in the case where some training is performed in response to a positive result determined at 810, the training parameters may be selected to avoid over-fitting of the DS 112 decision criteria.

In the case where decision 810 determines that offline DS 116 has predicted a value that is different from the value predicted by online DS 112 (e.g., outside of a defined margin), online DS 112 is negatively reinforced by training using online training engine 134 based on an output 118 computed by offline DS 116. The training is designed so that in the future, online DS 112 will converge to the offline DS's calculated value at output 118. The learning parameters, such as the frequency, the learning rate, and the number of learning iterations to be performed on online DS 112 per reinforcement mismatch is generally application- and situation-dependent.

At 814, offline training engine 136 is optionally called upon to perform positive reinforcement training of offline DS 116 to ensure that its sensitivity for the particular anomalous prediction, which can assist in improving in its time-series range of accurate prediction for a given anomaly. By the use of positive-reinforcement, offline DS 116 may learn a longer predictive window for the particular anomaly. The positive-reinforcement training at 814 may be performed incrementally to avoid the problem of overfitting. The learning parameters, including the frequency, the learning rate, and the learning iterations at which the offline DS 116 is positively reinforced is a heuristic that may be adjusted specifically in accordance with the type or properties of the anomaly detected.

At 818, the process advances the current time slice to the next time slice, and the process loops back to operation 802 for operation at the next discrete Lime slice.

Notably, while offline DS is almost always guaranteed to produce more accurate anomalous calculations, it is not used for real-time predictions. This is because the offline system waits S Lime slices before it can calculate an anomalous state for time slice T_(V−S), where V is the current time and S is the number of time slices that it must wait before making a calculation. For this reason, the online DS 112 is used to generate the actual real-time predictions.

To further illustrate applicability of some aspects of the embodiments, the following discussion illustrates application of the MLDS to detection of anomalies in data-center applications. Datacenters (DCs) have become increasingly important for next generation software systems due to the broad scope of computationally and spatially intense problems they can solve. Unfortunately, some aspects of the DC ecosystem are still in their infancy due to immature and evolving technologies, inconsistent and, sometimes, incompatible distributed properties, or the use of ad-hoc techniques from prior software stacks that are not well-suited for DC environments. In view of these challenges, utilization of DCs has not scaled as widely or accessibly as expected by some industry observers.

A notable challenge in the DC field has to do with the effectively identifying and resolving bugs in the performance and accuracy in a system that contains many heterogeneous components. Some examples of this heterogeneous complexity include sophisticated interactions between relational databases, key-value stores, message passing interface (MPI) distributed systems, and task and data parallel processes. Unfortunately, in many practical DCs, an anomaly that is caused by one of these component is often propagated and observed in another component. Some applications of the embodiments may be directed to correctness and performance analysis featuring a holistic view of the entire system so that it can properly analyze and associate anomalies that span its many disjoint components.

Some embodiments include a multi-component performance and correctness debugging ecosystem for DCs through the use of decision systems employing deep neural networks. By harvesting data semantics using both offline and online DS subsystems, some embodiments may naturally and automatically evolve through machine learning. Accordingly, an exemplary system may learn the intrinsic meaning of the DC's data from scalar, spatial, and temporal views. This may enable it to identify both correctness and performance anomalies more effectively, more exhaustively, and less erroneously than prior solutions. In addition, root-cause analysis may be performed for a given anomaly, even if such an anomaly spans several distributed components.

Data center operations can be described in terms of layers; a physical layer where all the hardware assets are run (servers, switches, cooling, etc.), a virtual layer that details how the workload is distributed on the physical assets (virtual machines, block, object storage, etc.) and a service layer that contains the services running within the data center. Customers and developers are given control over the service layer. In general, the services delivered by each entity within each layer is managed by different subsystems.

A data center infrastructure management (DCIM) system generally handles infrastructure-related issues (e.g., physical), while orchestration and control systems manage the applications running on them (e.g., virtual), Infrastructure/Platform/Software-as-a-Service portals manage the actual service request by the service developer. Each of the management components can be self-hosted on the infrastructure.

Within each layer, anomalies may occur, which result in performance degradation or correctness violations. Some embodiments apply the MLDS such as the MLDS exemplified above to learn behaviors based on telemetry data, which is processed by data adapters and later filtered by its data aggregator. The output from the DS's then informs the DC's control systems in place for each layer.

Telemetry data, which is processed by the data adapters, enables the system to learn the DC's behavior, and to enable an online and offline analysis. To make sure data is coming from all the right source, data adapters collect input data from entities across the service-delivery stack. This includes physical resources (CPUs, disks, memory, air conditioning, etc.), virtual entities (processes, virtual machines, containers, etc.) and the services itself (load-balancers, databases, etc.). Once this data is collected the data adapters then process them accordingly. The data aggregator publishes the data to data sinks such as databases for further processing. DS's, such as deep neural networks, perform the anomaly detection processing of the system.

### Additional Notes & Examples

Example 1 is a machine-learning decision system (MLDS) apparatus, comprising: an online decision system to produce a first time slice-specific decision output corresponding to a first time slice based on one or more situational inputs received in the first time slice; and an offline decision system to produce a second time slice-specific decision output corresponding to the first time slice based on one or more situational inputs received in the first time slice and in a plurality of subsequent time slices occurring after the first time slice; and an online training engine to conduct negative-reinforcement training of the online decision system in response to a nonconvergence between the first and the second time slice-specific decision outputs.

Example 2 is MLDS system of Example 1, further comprising: a training decision engine to compare the first time slice-specific decision output against the second time slice-specific decision output to determine the nonconvergence and a corresponding need to perform the negative-reinforcement training of the online decision system.

In Example 3, the subject matter of any one or more of Examples 1-2 optionally include an offline training engine to conduct unsupervised positive-reinforcement training of the offline decision system in response to a nonconvergence between the first and the second time slice-specific decision outputs.

In Example 4, the subject matter of any one or more of Examples 1-3 optionally include wherein the online training engine is further to conduct positive-reinforcement training of the online decision system in response to a convergence between the first and the second time slice-specific decision outputs.

In Example 5, the subject matter of any one or more of Examples 1-4 optionally include a data adapter to receive input data from a plurality of data sources, and to transform the input data into a transformed representation.

In Example 6, the subject matter of Example 5 optionally includes wherein the input data consists of N data elements, and wherein the transformed representation includes M data elements, wherein M is greater than N.

In Example 7, the subject matter of any one or more of Examples 1-6 optionally include a data aggregator to receive input data from a plurality of data sources, and produce a time-ordered restructuring of the input data.

In Example 8, the subject matter of any one or more of Examples 1-7 optionally include wherein the online decision system and the offline decision system are each an anomaly detection decision system.

In Example 9, the subject matter of any one or more of Examples 1-8 optionally include wherein the online decision system and the offline decision system are each a deep neural network (DNN).

In Example 10, the subject matter of any one or more of Examples 1-9 optionally include wherein the first time slice-specific decision output and the second time slice-specific decision output are each a binary value.

In Example 11, the subject matter of any one or more of Examples 1-10 optionally include wherein the first time slice-specific decision output and the second time slice-specific decision output are each a graded-score value.

In Example 12, the subject matter of any one or more of Examples 1-11 optionally include wherein the first time slice-specific decision output is a real-time assessment that is fed to a real-time control system as an input to the control system.

Example 13 is at least one machine-readable medium containing instructions that, when executed on a computing platform, cause the computing platform to: execute an online decision process to produce a first time slice-specific decision output corresponding to a first time slice based on one or more situational inputs received in the first time slice; and execute an offline decision process to produce a second time slice-specific decision output corresponding to the first time slice based on one or more situational inputs received in the first time slice and in a plurality of subsequent time slices occurring after the first time slice; and execute an online training process to conduct negative-reinforcement training of the online decision process in response to a nonconvergence between the first and the second time slice-specific decision outputs.

In Example 14, the subject matter of Example 13 optionally includes instructions that, when executed on a computing platform, cause the computing platform to compare the first time slice-specific decision output against the second time slice-specific decision output to determine the nonconvergence and a corresponding need to perform the negative-reinforcement training of the online decision process.

In Example 15, the subject matter of any one or more of Examples 13-14 optionally include instructions that, when executed on a computing platform, cause the computing platform to execute an offline training process to conduct unsupervised positive-reinforcement training of the oftline decision process in response to a nonconvergence between the first and the second time slice-specific decision outputs.

In Example 16, the subject matter of any one or more of Examples 13-15 optionally include wherein the online training process is to conduct positive-reinforcement training of the online decision process in response to a convergence between the first and the second time slice-specific decision outputs.

In Example 17, the subject matter of any one or more of Examples 13-16 optionally include instructions that, when executed on a computing platform, cause the computing platform to execute a data adapter process to receive input data from a plurality of data sources, and to transform the input data into a transformed representation.

In Example 18, the subject matter of Example 17 optionally includes wherein the input data consists of N data elements, and wherein the transformed representation includes M data elements, wherein M is greater than N.

In Example 19, the subject matter of any one or more of Examples 13-18 optionally include instructions that, when executed on a computing platform, cause the computing platform to receive input data from a plurality of data sources, and produce a time-ordered restructuring of the input data.

In Example 20, the subject matter of any one or more of Examples 13-19 optionally include wherein the online decision process and the offline decision process are each an anomaly detection decision process.

In Example 21, the subject matter of any one or more of Examples 13-20 optionally include wherein the online decision process and the offline decision process are each a deep neural network (DNN) process.

In Example 22, the subject matter of any one or more of Examples 13-21 optionally include wherein the first time slice-specific decision output and the second time slice-specific decision output are each a binary value.

In Example 23, the subject matter of any one or more of Examples 13-22 optionally include wherein the first time slice-specific decision output and the second time slice-specific decision output are each a graded-score value.

In Example 24, the subject matter of any one or more of Examples 13-23 optionally include wherein the first time slice-specific decision output is a real-time assessment that is fed to a real-time control system as an input to the control system.

Example 25 is a machine-implemented method for operating a machine-learning decision system (MLDS), the method comprising: executing an online decision system to produce a first time slice-specific decision output corresponding to a first time slice based on one or more situational inputs received in the first time slice; and executing an offline decision system to produce a second time slice-specific decision output corresponding to the first time slice based on one or more situational inputs received in the first time slice and in a plurality of subsequent time slices occurring after the first time slice; and executing an online training process to conduct negative-reinforcement training of the online decision system in response to a nonconvergence between the first and the second time slice-specific decision outputs.

In Example 26, the subject matter of Example 25 optionally includes comparing the first time slice-specific decision output against the second time slice-specific decision output to determine the nonconvergence and a corresponding need to perform the negative-reinforcement training of the online decision system.

In Example 27, the subject matter of any one or more of Examples 25-26 optionally include executing an offline training process to conduct unsupervised positive-reinforcement training of the offline decision system in response to a nonconvergence between the first and the second time slice-specific decision outputs.

In Example 28, the subject matter of any one or more of Examples 25-27 optionally include wherein the online training process is to conduct positive-reinforcement training of the online decision system in response to a convergence between the first and the second time slice-specific decision outputs.

In Example 29, the subject matter of any one or more of Examples 25-28 optionally include receiving input data from a plurality of data sources, and transforming the input data into a transformed representation.

In Example 30, the subject matter of Example 29 optionally includes wherein the input data consists of N data elements, and wherein the transformed representation includes M data elements, wherein M is greater than N.

In Example 31, the subject matter of any one or more of Examples 25-30 optionally include receiving input data from a plurality of data sources, and grouping the input data by time slice and by data source to produce a time-ordered restructuring of the input data.

In Example 32, the subject matter of any one or more of Examples 25-31 optionally include wherein the online decision system and the offline decision system are each an anomaly detection decision system.

In Example 33, the subject matter of any one or more of Examples 25-32 optionally include wherein the online decision system and the offline decision system each perform execution of a deep neural network (DNN) process.

In Example 34, the subject matter of any one or more of Examples 25-33 optionally include wherein the first time slice-specific decision output and the second time slice-specific decision output are each a binary value.

In Example 35, the subject matter of any one or more of Examples 25-34 optionally include wherein the first time slice-specific decision output and the second time slice-specific decision output are each a graded-score value.

In Example 36, the subject matter of any one or more of Examples 25-35 optionally include wherein the first time slice-specific decision output is a real-time assessment, and wherein the method further comprises feeding the real-time assessment to a real-time control system as an input to the control system.

Example 37 is a machine-learning decision system (MLDS), the system comprising: online means for producing a first time slice-specific decision output corresponding to a first time slice based on one or more situational inputs received in the first time slice; and offline means for producing a second time slice-specific decision output corresponding to the first time slice based on one or more situational inputs received in the first time slice and in a plurality of subsequent time slices occurring after the first Lime slice; and first training means for training the online means, the first training means including means for conducting negative-reinforcement training of the online means in response to a nonconvergence between the first and the second time slice-specific decision outputs.

In Example 38, the subject matter of Example 37 optionally includes means for comparing the first time slice-specific decision output against the second time slice-specific decision output to determine the nonconvergence and a corresponding need to perform the negative-reinforcement training of the online means.

In Example 39, the subject matter of any one or more of Examples 37-38 optionally include second training means for training the offline means, the second training means including means for conducting unsupervised positive-reinforcement training of the offline means in response to a nonconvergence between the first and the second time slice-specific decision outputs.

In Example 40, the subject matter of any one or more of Examples 37-39 optionally include wherein the first training means is to conduct positive-reinforcement training of the online decision system in response to a convergence between the first and the second Lime slice-specific decision outputs.

In Example 41, the subject matter of any one or more of Examples 37-40 optionally include means for receiving input data from a plurality of data sources, and for transforming the input data into a transformed representation.

In Example 42, the subject matter of Example 41 optionally includes wherein the input data consists of N data elements, and wherein the transformed representation includes M data elements, wherein M is greater than N.

In Example 43, the subject matter of any one or more of Examples 37-42 optionally include means for receiving input data from a plurality of data sources, and for grouping the input data by time slice and by data source to produce a time-ordered restructuring of the input data.

In Example 44, the subject matter of any one or more of Examples 37-43 optionally include wherein the online means and the offline means each include means for anomaly detection.

In Example 45, the subject matter of any one or more of Examples 37-44 optionally include wherein the online means and the offline means each include means for executing a deep neural network (DNN).

In Example 46, the subject matter of any one or more of Examples 37-45 optionally include wherein the first time slice-specific decision output and the second time slice-specific decision output are each a binary value.

In Example 47, the subject matter of any one or more of Examples 37-46 optionally include wherein the first time slice-specific decision output and the second time slice-specific decision output are each a graded-score value.

In Example 48, the subject matter of any one or more of Examples 37-47 optionally include wherein the first time slice-specific decision output is a real-time assessment, and wherein the system further comprises means for feeding the real-time assessment to a real-time control system as an input to the control system.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A machine-learning decision system (MLDS), comprising:
an online decision system to produce a first time slice-specific decision output corresponding to a first time slice based on one or more situational inputs received in the first time slice; and
an offline decision system to produce a second time slice-specific decision output corresponding to the first time slice based on one or more situational inputs received in the first time slice and in a plurality of subsequent time slices occurring after the first time slice; and
an online training engine to conduct negative-reinforcement training of the online decision system in response to a nonconvergence between the first and the second time slice-specific decision outputs.

2. The MLDS system of claim 1, further comprising:
a training decision engine to compare the first time slice-specific decision output against the second time slice-specific decision output to determine determine the nonconvergence.

3. The MLDS system of claim 1, further comprising:
an offline training engine to conduct unsupervised positive-reinforcement training of the offline decision system in response to a nonconvergence between the first and the second time slice-specific decision outputs.

4. The MLDS system of claim 1, wherein the online training engine is further to conduct positive-reinforcement training of the online decision system in response to a convergence between the first and the second time slice-specific decision outputs.

5. The MLDS system of claim 1, further comprising:
a data adapter to receive input data from a plurality of data sources, and to transform the input data into a transformed representation.

6. The MLDS system of claim 5, wherein the input data consists of N data elements, and wherein the transformed representation includes M data elements, wherein M is greater than N.

7. The MLDS system of claim 1, further comprising:
a data aggregator to receive input data from a plurality of data sources, and produce a time-ordered restructuring of the input data.

8. The MLDS system of claim 1, wherein the online decision system and the offline decision system are each an anomaly detection decision system.

9. The MLDS system of claim 1, wherein the online decision system and the offline decision system are each a deep neural network (DNN).

10. The MLDS system of claim 1, wherein the first time slice-specific decision output and the second Lime slice-specific decision output are each a binary value.

11. The MLDS system of claim 1, wherein the first time slice-specific decision output and the second time slice-specific decision output are each a graded-score value.

12. The MLDS system of claim 1, wherein the first time slice-specific decision output is a real-time assessment that is fed to a real-time control system as an input to the control system.

13. At least one machine-readable medium containing instructions that, when executed on a computing platform, cause the computing platform to:
execute an online decision process to produce a first time slice-specific decision output corresponding to a first time slice based on one or more situational inputs received in the first time slice; and
execute an offline decision process to produce a second time slice-specific decision output corresponding to the first time slice based on one or more situational inputs received in the first time slice and in a plurality of subsequent time slices occurring after the first time slice; and
execute an online training process to conduct negative-reinforcement training of the online decision process in response to a nonconvergence between the first and the second time slice-specific decision outputs.

14. The at least one machine-readable medium of claim 13, further comprising:
instructions that, when executed on a computing platform, cause the computing platform to compare the first time slice-specific decision output against the second time slice-specific decision output to determine the nonconvergence and a corresponding need to perform the negative-reinforcement training of the online decision process.

15. The at least one machine-readable medium of claim 13, further comprising:
instructions that, when executed on a computing platform, cause the computing platform to execute an offline training process to conduct unsupervised positive-reinforcement training of the offline decision process in response to a nonconvergence between the first and the second time slice-specific decision outputs.

16. The at least one machine-readable medium of claim 13, wherein the online training process is to conduct positive-reinforcement training of the online decision process in response to a convergence between the first and the second time slice-specific decision outputs.

17. The at least one machine-readable medium of claim 13, further comprising:
instructions that, when executed on a computing platform, cause the computing platform to execute a data adapter process to receive input data from a plurality of data sources, and to transform the input data into a transformed representation.

18. The at least one machine-readable medium of claim 17, wherein the input data consists of N data elements, and wherein the transformed representation includes M data elements, wherein M is greater than N.

19. The at least one machine-readable medium of claim 13, further comprising:
instructions that, when executed on a computing platform, cause the computing platform to receive input data from a plurality of data sources, and produce a time-ordered restructuring of the input data.

20. A machine-implemented method for operating a machine-learning decision system (MLDS), the method comprising:
executing an online decision system to produce a first time slice-specific decision output corresponding to a first time slice based on one or more situational inputs received in the first time slice; and
executing an offline decision system to produce a second time slice-specific decision output corresponding to the first time slice based on one or more situational inputs received in the first time slice and in a plurality of subsequent time slices occurring after the first time slice; and
executing an online training process to conduct negative-reinforcement training of the online decision system in response to a nonconvergence between the first and the second time slice-specific decision outputs.

21. The method of claim 20, further comprising:
comparing the first time slice-specific decision output against the second time slice-specific decision output to determine the nonconvergence and a corresponding need to perform the negative-reinforcement training of the online decision system.

22. The method of claim 20, further comprising:
executing an offline training process to conduct unsupervised positive-reinforcement training of the offline decision system in response to a nonconvergence between the first and the second time slice-specific decision outputs.

23. The method of claim 20, wherein the online training process is to conduct positive-reinforcement training of the online decision system in response to a convergence between the first and the second time slice-specific decision outputs.

24. The method of claim 20, further comprising:
receiving input data from a plurality of data sources, and transforming the input data into a transformed representation.

25. The method of claim 20, further comprising:
receiving input data from a plurality of data sources, and producing a time-ordered restructuring of the input data.
